(19) United States
(12) Patent Application Publication
(10) Pub. No.: US 2024/0077859 A1
(43) Pub. Date: Mar. 7, 2024

(54) METHOD AND DEVICE FOR VISUALIZING OR EVALUATING A PROCESS STATUS

(71) Applicant: ENGEL AUSTRIA GmbH, Schwertberg (AT)

(72) Inventors: Josef GIESSAUF, Perg (AT); Richard DENK, Linz (AT)

(21) Appl. No.: 18/215,548

(22) Filed: Jun. 28, 2023

(30) Foreign Application Priority Data
Jul. 11, 2022 (AT) A 50506/2022

(51) Int. Cl. G05B 19/418

(52) U.S. Cl. CPC G05B 19/41885; G05B 2219/32351; G05B 2219/33125

(57) ABSTRACT

A method includes determining the value of a plurality of selected process variables. Preferably, the respective current value of each selected process variable or a variable derived therefrom is compared with one or more reference values, and in each case at least one deviation or at least one rate of change is determined. On the basis of the determined plurality of deviations and/or rates of change, a stability of a current process state is determined. A computing unit visualizes a process states determined for different points in time and/or cycles by a chart such that a trajectory of the stability of process states for a predetermined period of time and/or over multiple cycles is visible in the chart. The computing unit visualizes a reference that, at a certain point in time, at least one factor was existing which is relevant for an evaluation of the result of the stability's trajectory.

The present invention concerns a method for visualizing the stability of a process state of a production plant comprising at least one cyclically operating molding machine and optionally at least one peripheral device having the features of the generic term of claim 1, a device for visualizing a stability of a process state of such a production plant having the features of the generic term of claim 7, a production plant comprising such a device, a computer program, a computer-readable data carrier and a data carrier signal.

Methods and devices of the prior art offer the possibility to display and/or monitor hundreds of process variables determined from measured values in the form of key figures. Such key figures can be for instance minima, maxima, mean values or integrals of measuring curves that have been recorded within a cyclic production process (production cycle). Typically, such curves are a function of time. Further key figures can also be points in time (from the start of the measurement) to which the curve takes on a certain characteristic, i.e. point in time of the maximum/minimum, point in time at which the integral exceeds a certain value, point in time at which a defined value is reached, exceeded or fallen short of, etc.

Key figures can also be derived from the combination of measurements with different sensors. If, for instance, the screw position, injection pressure and internal mold pressure are measured during injection on a plastic injection molding machine, the connecting parameter “time” or sequence of cycles can be used to determine key figures such as the screw position at which the maximum injection pressure is reached, the internal mold pressure at the front screw position or the like.

First of all, there is no expected value for key figures (unlike actual values, for which there is usually an assigned target value); they often result from several factors. One example is the maximum injection pressure in a plastic injection molding machine, which results from factors such as injection speed, geometry of the mold cavity, melt viscosity and mold temperature. This is precisely why these variables are so interesting, as they can be used to draw conclusions about influencing variables that are not measurable or not measured directly, or about the changes in these variables.

Of particular interest is the question of how stable a process state is.

The stability of a process state at a current point in time or in a current cycle can be determined, for instance, in the following way:
1. Setting or determining a reference point in time (or time span) or reference cycle (or cycle span). This setting can be done automatically or by the user. This reference can remain the same until further notice or can change over time (“floating reference”).
2. Determining the reference values for a plurality of process variables and/or variables derived therefrom (e.g. key figures), resulting in a reference state for the process state to be assessed.
3. Setting or determining the permitted deviations or change rates of the plurality of process variables and/or variables derived therefrom.
4. Comparison of the current values of the plurality of process variables and/or variables derived therefrom with their assigned reference values, and determination of deviations or change rates. A process variable and/or variable derived therefrom is evaluated as instable if its deviation or change rate exceeds a defined permitted deviation or change rate.
5. Calculation of the stability of the process state according to a defined rule. This rule can take into account the number of instable parameters, the degree of instability or a combination thereof. In the simplest case, the process state is then regarded as instable if at least one process variable and/or variable derived from it is instable.

A stable process state in terms of the invention can be achieved, for instance, by:
Quality of the process settings: Setpoints are selected in such way that
   the process is resistant to environmental influences
   they are actually achieved or can be achieved
   they are suitable regarding the processed material.
good state of elements of the production plant (e.g. the backflow barrier, the tool, etc.)
good state of the processed material
low influence of unmeasured disturbance variables (e.g. ambient temperature, draft, etc.)

A very simple device for visualizing a process state of a molding machine is described in DE 10 2007 013 044 B4. There, a stability parameter generated from various process parameters is visualized by means of light indicators. When problems occur, it is very difficult to clarify the cause of the problem.

This problem is solved by the methods and devices for visualizing and/or assessing a state of a production plant disclosed in EP 3 551 420 A1, EP 3 754 447 A1, EP 3 804 951 A1 and EP 21183477.5 (not yet published).

In EP 3 551 420 A1, a merging of the assessment of individual process variables in several hierarchical levels takes place, thus offering a user a structured overall view of the process state, starting from which the user can get an impression of the state of the process state of the production plant along the hierarchical structure in different levels down to the individual process variables.

The method disclosed in EP 3 754 447 A1 and EP 3 804 951 A1 makes it possible, taking into account at least one set of process variables (that is, at least two different process variables of the production plant or at least one process variable with at least one derived variable), to classify at least one actual process state in such way that measures relating to the at least one process state can be pointed out, and information about the actual process state is output.

In EP 21183477.5, a reduction of the process requirements to a computing unit takes place when carrying out one of the methods described in EP 3 551 420 A1, EP 3 754 447 A1 or EP 3 804 951 since only selected process variables are processed.

Although the methods described so far provide an essential advantage regarding the visualization and/or assessment of a process state of a production plant compared to the former prior art, as it is possible to obtain an almost complete transparency of a process state of a production plant by monitoring hundreds of process variables, it would be desirable to be able to provide additional information to a user in order to reduce a risk of misinterpretation of the instability of a process state.

The object of the invention is to provide a method and a device where the risk of misinterpretation of an instability of a process condition is reduced.

This object is accomplished by a method having the features of claim 1, a device having the features of claim 7, a production plant having such a device, a computer program having the features of claim 14, a computer-readable data carrier having the features of claim 15, and a data carrier signal having the features of claim 16. Advantageous embodiments of the invention are defined in the dependent claims.

As regards the method for visualizing the stability of a process state of a production plant which contains at least one molding machine operating in cycles and optionally at least one peripheral device, it is provided that
by means of a computing unit time-continuously or time-discretely
   the value of a plurality of selected process variables is determined, and the, preferably in each case current, value of each selected process variable or a variable derived therefrom is compared with one or more reference values, and at least one deviation or at least one change rate is determined in each case, and
   a stability of a current process state is determined on the basis of the determined plurality of deviations or change rates
the computing unit visualizes the process states determined for different points in time and/or cycles by means of a chart (visible at a glance) in such way that a trajectory of the stability of process states for a predetermined period of time and/or over several cycles is visible in the chart, and
the computing unit, in addition to visualizing the trajectory of the stability of process states, visualizes a reference that at a certain point in time or for a certain time span at least one factor was existing which is relevant for an evaluation of the result of the stability's trajectory

The device for visualizing the stability of a process state of a production plant, which comprises at least one cyclically operating molding machine and optionally at least one peripheral device, has at least:
a display device
a computing unit which is in data-transmitting connection with the display device or which is configured to be brought into data-transmitting connection with the display device, and which is configured to time-continuously or time-discretely
   determine the value of a plurality of selected process variables of the production plant and comparing the, preferably in each case current, value of each selected process variable or a variable derived therefrom with one or more reference values, and determining a deviation or a change rate in each case
   a stability of a current process state is determined on the basis of the determined plurality of deviations and/or change rates
the computing unit is furthermore configured to
   visualize the process states determined for different points in time and/or cycles by means of a chart (visible at a glance) in such way that a trajectory of the stability of process states for a predetermined time span and/or over several cycles is visible in the chart, and
   in addition to the visualization of the trajectory of the process states' stability, to visualize a reference assigned to the particular point in time or to the particular time span that at least one factor was existing at the particular point in time or for the particular time span which is relevant for an evaluation of the result of the stability's trajectory

Examples of the at least one factor relevant for evaluating the result of the stability's trajectory are:
a special operating mode of the production plant and/or
a change in the target value and/or
a change in the configuration of the production plant (e.g. change of a mounted molding tool, change of peripheral devices used, replacement of a component of the molding machine such as mass cylinder, screw, etc.) and/or
a change by the user and/or
a change of the control mode (e.g. change of the controlled variable, like from flow rate of a temperature control unit to temperature difference of the temperature control medium, etc.) and/or
a change of a sequence of motions and/or
active alarms of the molding machine or of a peripheral device, if present, and/or
change of the operating mode of a peripheral device, if present (e.g. switching on a material conveyor device) and/or
manual or automatic maintenance or servicing measures (e.g. automatic lubrication is active) and/or
comments edited by a user

The at least one factor represents a possible explanation as to why the stability has changed. It is relevant for an evaluation of the result of the stability's trajectory because the events, processes, or states represented by it indicate that a deterioration in stability is attributable to an external intervention rather than an intrinsic problem with the production plant.

For instance, if a user knows that a change in the target value has taken place, he/she understands that a subsequent deterioration in stability is attributable to transient responses.

When referring to determining the value of a plurality of selected process variables and the value of each selected process variable or a variable derived therefrom is compared to one or more reference values, and at least one deviation or at least one change rate is determined in each case, this can mean:
comparing the current values existing at a particular point in time or cycle with one or more reference values
comparing the current values existing over a certain time span or number of cycles with one or more reference values, for instance comparing values averaged over the certain time span or number of cycles with the one or more reference values

Determining the stability of a process state can be performed, for instance, as described in the introduction to the present description.

Such a method and such a device not only provide a quick overview of the stability's trajectory of the production plant's (global) process state over time or cycles, but, by visualized reference, enable a user to be alerted to the fact that a special operation mode and/or target value change of the production plant was exiting at a particular point in time or for a particular time span, and therefore any possible instability of the process state for that point in time or time span is not of concern.

By monitoring hundreds of parameters, an unprecedented transparency enters the molding process. This can lead to misinterpretations (over-detections), especially in the case of subsequent process analysis, if another than the regular operating mode in the form of the regular production mode (i.e. a special operating mode and/or a target value change) is active, for instance:
optimizations carried out automatically in the background by assistance systems
process optimization by the user
start-up following standstill

These listed circumstances usually lead to the fact that a deviation is detected and visualized, which is really existing, but is not caused by an error or a problem.

The selection of the additional information provided by the visualized reference is carried out in such way that a “drill-down” by the user from the global information to detailed information in a plurality of situations to be expected is not necessary, as the additional information is able to provide the explanation for a deviation of the global process state from the stable ideal state. The visualization makes the sequence of information comprehensible at a glance.

Depicting a change can, for instance, be such that the user is immediately made aware of the change itself, or that the before-state is visualized close to the after-state.

In some embodiments of the method and device, it is provided that the visualization of the stability of process states is in the form of a bar the length of which represents the trajectory of time or cycles, wherein points in time or time spans of different stability are visualized by
markings or alphanumeric data below and/or above and/or within the bar and/or
a differing graphic design of the bar (in particular by means of different colors, e.g. green color if there is stability and orange or red color if there is instability)

It can be provided that a degree of instability is visualized as well, e.g. by an intensity of a color, the visualization of a number of instable process variables or by visualization of a preferably normed and summed-up distance of actual values to reference values.

In some embodiments of the method and device, it is provided that a special operation mode of the production plant is provided in the form of at least one of the following specifications:
change in the production mode, change in the components of the production cell, especially the tool or peripheral devices, change in the operator, change in a control mode, change in the sequence, carrying out maintenance, comments by the user, exceeding of monitoring or warning limits, rejects
run-in cycles or automatic process optimizations by assistance systems, activity of peripheral devices (e.g. material conveying devices), carrying out regular processes such as lubrication of components automatically
control mode of a flow controller or control mode of a process controller, for instance for automatic control of an injected volume, existence of alarms at the molding machine or a peripheral device (e.g. as described in EP 2 583 811 B1)

In some embodiments of the method and device, it is provided (individually or in any combination) that
events, processes or states are visualized by pictograms
references are visualized even if everything is stable; however, they can also directly provide the explanation for an instable phase
additional information of the references, combined in a reasonable manner, can be visualized in a common or in several separate lanes (“swimlanes”) and/or as an overlay for the assessment of the process state

In some embodiments of the method and device, it is provided that
each selected process variable is assigned to at least one logical group by the computing unit, wherein at least two different logical groups are provided
it is preferably provided that logical groups are arranged in at least two hierarchical levels such that at least one logical group of a lower hierarchical level is assigned to another logical group of a higher hierarchical level
for each logical group, a state of the logical group is assessed and/or visualized by the computing unit on the basis of the process variables assigned to this logical group

This way, the invention is realized in a method or device according to EP 3 551 420 A1, EP 3 754 447 A1, EP 3 804 951 A1 or EP 21183477.5.

Each production plant has one (preferable only one) cyclically operating molding machine. A cyclically operating molding machine can, of course, have several cyclically operating subunits, in particular several cyclically operating plasticizing and/or injection units. In this case, the cycle of the production plant is to be understood as that time span which results when all cyclically operating subunits are taken into account.

Optionally, the production plant also has machines, devices and apparatuses connected upstream and downstream of the molding machine or running parallel, each of which can provide process variables and preferably, are equipped with sensors for determining measurement data. Examples include, besides peripheral devices, devices and plants for supplying the molding machine or the molding tool (cooling and temperature control devices, material conveyors, dosing and mixing plants), for processing the raw material (dryers, dust extractors), devices for manipulating the molded parts (robots, conveyor belts, separating diverters), plants for quality inspection (optical image processing, scales, measuring equipment), plants for further processing or further treatment of the molded parts or systems for measuring additional process variables from the tool (internal mold pressure, temperature, mold breathing or tool expansion or the environment.

The term production plant is to be distinguished from the term production site, which has a plurality of production plants in a spatially defined area (e.g., a production hall). The invention relates to one production plant but can, of course, be applied to any number of production plants.

Preferably, the molding machine is an injection molding machine, particularly preferably a plastic injection molding machine.

Preferably, the at least one peripheral device, if present, is a handling device (e.g. robot).

The computing unit and/or the storage unit can be arranged in spatial unity with the production plant, preferably in constructional unity with the molding machine and/or with the possibly existing at least one peripheral device (e.g. as part of a machine control of the production plant). The computing unit and/or the storage unit can, however, additionally or alternatively be arranged spatially remote from the production plant (cloud solution) or be located in a common (for instance local) network with one or more production plants.

The output device can have a screen and, if applicable, a signal generation device for generating and outputting acoustic or visual signals. The output device can be designed as a user interface of the production plant.

Examples of molding machines are injection molding machines, in particular plastic injection molding machines, injection presses and injection embossing machines.

In the context of the present disclosure, any reference to a production plant can be understood as referring only to the molding machine of the production plant, only to the at least one peripheral device, if present, or to the collectivity of the molding plant and the at least one peripheral device.

Therefore, in the context of the present disclosure, any reference to the stability of the process state of a production plant can be understood as a reference only to the stability of the process state of a molding machine of the production plant, only to the stability of the process state of at least one peripheral device, if present, or to the stability of the process state of the collectivity of the molding plant and at least one peripheral device.

Embodiments of the invention are discussed referring to the figures. They show:

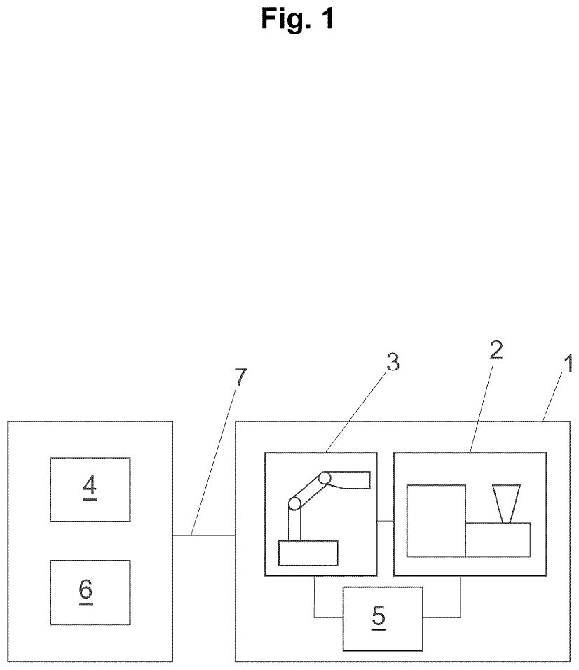

FIG. 1 a schematic view of a production plant

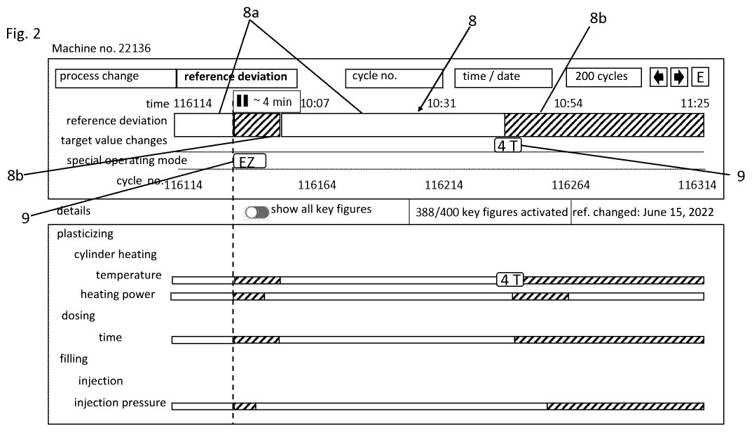

FIG. 2 an embodiment of a display device with visualized stability of the process state and additionally visualized reference of special operating modes

The production plant 1 shown exemplary in FIG. 1 shows a molding machine 2 and a handling device 3. A computing unit 4 and a storage medium 6, in which a computer program according to the invention is saved, are connected to a display device 5 via a data connection 7. The display device 5 can be designed in any known manner. Other than shown, the computing unit 4 and/or the storage medium 6 can be a part of the molding machine 2, for instance a part of the machine control.

In an upper portion of a chart, FIG. 2 shows the visualization of the stability of a process state by means of a bar 8, which has differently colored portions 8a, 8b, wherein the color signals the stability or instability. In the lanes “target value changes” and “special operating mode”, additional information on the factors relevant for an assessment of the stability's trajectory is shown by means of visualized references 9, which support the interpretation by relativizing the portions with an instable process state. “EZ” indicates run-in cycles and “4T” indicates that four target value changes have been carried out in the “temperature” portion.

In the present embodiment, two different types of monitoring are available, the “process change”, in which a comparison is made with immediately preceding cycles (co-moving comparison point), and the “reference deviation”, in which a comparison is made with one or more fixed reference states.

In the present example, 388 out of 400 possible key figures are taken into account for determining the stability because they have been activated (or not deactivated) by the user.

By means of a filter it can be selected whether only those key figures that are instable at least once in the current observation window or all activated parameters (switch “show all key figures”) should be displayed.

Optional details are shown in the lower portion, as is known from the prior art cited by the applicant at the beginning. It can be seen that in this case the stability has been determined in the simplest possible way, such that an instability is considered to be detected if even only one of the monitored process variables (here e.g. groups of temperature process variables) deviates more than a predetermined distance from a target value.

### LIST OF REFERENCE SIGNS AND TERMINOLOGY

1 production plant
2 molding machine
3 handling device
4 computing unit
5 display device
6 storage medium
7 data connection
8 bar
8a portion of the bar with stable process state
8b portion of the bar with instable process condition
9 reference
measured value value provided by a sensor or value of a physical quantity of the production plant, one of its components or the processed material determined on the basis of the signals provided by the sensor
process variable variable determined from measured value(s), can be represented in the form of one or more key figures
process state reflects the situation of the production plant regarding at least one parameter, preferably regarding a plurality of parameters, during the production process running in molding cycles; the term process state can refer only to the molding machine of the production plant, only to the at least one peripheral device, if present, or to the totality of molding plant and at least one peripheral device
stability referring to a process state, a statement about whether and, if so, up to which degree the process state has changed compared to at least one reference state
key figure variable determined from process variable, such as measured values determined from measured curves, characteristics of measured curves; point in time at which measured variables take up certain values, etc.
target value set variable for the production plant
reference value value used for a comparison with a process variable
reference state a combination of reference values at a certain point in time, which characterizes the state of the production plant or of parts of it at this point in time

1. A method for visualizing the stability of a process state of a production plant, which contains at least one molding machine operating in cycles and, if applicable, contains at least one peripheral device, wherein, by means of a computing unit, time-continuously or time-discretely:
the value of a plurality of selected process variables is determined, and preferably the respective current value of each selected process variable or a variable derived therefrom is compared with one or more reference values, and in each case at least one deviation or at least one rate of change is determined,
based on the determined plurality of deviations and/or rates of change, a stability of a current process state is determined,
the computing unit visualizes the process states determined for different points in time and/or cycles by means of a chart in such way that a trajectory of the stability of process states for a predetermined period of time and/or over several cycles is visible in the chart, and
in addition to the visualization of the trajectory of the stability of process states, the computing unit visualizes at least one reference indicating that to a certain point in time or for a certain period of time at least one factor was existing, which is relevant for an evaluation of the result of the stability's trajectory.

2. The method according to claim 1, wherein the at least one factor relevant for an evaluation of the result of the stability's trajectory is:
a special operation mode of the production plant, and/or
a target value change and/or
a change in the configuration of the production plant (e.g. change of a mounted molding tool, change of the peripheral devices used, replacement of a component of the molding machine such as a mass cylinder, screw, etc.), and/or
a change by the user, and/or
a change in the control mode (e.g. changing the controlled variable, such as from flow rate of a temperature control unit to temperature difference of the temperature control medium, etc.), and/or
a change of a sequence of motions, and/or
active alarms of the molding machine or of a peripheral device that may be existing, and/or
change of the operating mode of a peripheral device that may be existing (e.g. switching on a material conveyor device), and/or
manual or automatic maintenance or service measures (e.g. automatic lubrication is active), and/or
comments edited by a user.

3. The method according to claim 1, wherein the visualization of the stability of process states is shown in form of a bar, the length of which represents the trajectory of time or cycles, wherein points of time or time spans of different stability are visualized by
markings or alphanumeric information below and/or above and/or within the bar, and/or
a different graphic design of portions of the bar, and
wherein it is preferably provided that a degree of instability is also visualized, particularly preferably by an intensity of a color, the visualization of a number of instable process variables or by visualization of a preferably normed and summed up distance of actual values to reference values.

4. The method according to claim 1, wherein there is a special mode of operation of the production plant in the form of at least one of the following:
change in the production mode, change in the components of the production cell, particularly of the tool or peripheral devices, change in the operating personnel, change in a control mode, change in the operating procedure, carrying out maintenance, comments by the user, exceeding of monitoring or warning limits, rejects,
run-in cycles or automatic process optimizations by assistance systems, activity of peripheral devices (e.g. material conveying devices), carrying out regular operations automatically, such as lubrication of components, and
control mode of a flow controller or control mode of a process controller, for instance for controlling an injected volume automatically, presence of alarms at the molding machine or a peripheral device.

5. The method according to claim 1, wherein the visualization of the reference is carried out only in case there is an impairment of a stability of the process state at a certain point in time or for a certain time span, in particular when it is to be attributed to one of the factors relevant for the assessment.

6. The method according to claim 1, wherein
each selected process variable is assigned to at least one logical group by the computing unit, wherein at least two different logical groups are provided,
it is preferably provided that logical groups are arranged in at least two hierarchy levels in such way that at least one logical group of a lower hierarchy level is assigned to another logical group of a higher hierarchy level, and
for each logical group, a state of the logical group on the basis of the process variables assigned to this logical group is assessed and/or visualized by the computing unit.

7. A device for visualizing the stability of a process state of a production plant comprising at least one cyclically operating molding machine and optionally at least one peripheral device, in particular for carrying out a method according to claim 1, comprising:
a display device
a computing unit which is in data connection with the display device via a data connection or which is configured to be brought into a data connection with the display device, and which is configured to time-continuously or time-discretely
determine the value of a plurality of selected process variables of the production plant and, comparing the, preferably respective current, value of each selected process variable or a variable derived therefrom with one or more reference values, and in each case determining a deviation or a rate of change,
a stability of a current process state is determined on the basis of the determined plurality of deviations and/or rates of change,
the computing unit is furthermore configured:
to visualize the process states determined for different points in time and/or cycles by means of a chart such that a trajectory of the stability of process states for a predetermined period of time and/or over several cycles is visible in the chart, and
in addition to visualizing the stability's trajectory of process states, to visualize at least one reference that at a certain point in time or for a certain period of time at least one factor was existing which is relevant for an evaluation of the result of the stability's trajectory.

8. The device according to claim 7, wherein the at least one factor relevant for an evaluation of the result of the stability's trajectory is:
a special mode of operation of the production plant, and/or
a target value change, and/or
a change in the configuration of the production plant (e.g. change of a mounted molding tool, change of peripheral devices used, replacement of a component of the molding machine such as a mass cylinder, screw, etc.) and/or a change by the user, and/or
a change of the control mode (e.g. change of the controlled variable, such as from flow rate of a temperature control unit to temperature difference of the temperature control medium, etc.), and/or
a change of a sequence of motions, and/or
active alarms of the molding machine or a peripheral device, if present, and/or
change of the operating mode of a peripheral device, if present (e.g. switching on a material conveying device), and/or
manual or automatic maintenance or servicing measures (e.g. automatic lubrication is active), and/or
comments edited by a user.

9. The device according to claim 1, wherein the computing unit is configured to visualize the stability of process states in the form of a bar, the length of which represents the trajectory of time or cycles, wherein points in time or time spans of different stability are visualized by:
markings or alphanumeric information below and/or above and/or within the bar, and/or
a different graphic design of portions of the bar, and
wherein it is preferably provided that a degree of instability is also visualized, particularly preferably by an intensity of a color, the visualization of a number of instable process variables or by visualization of a preferably normed and summed up distance of actual values to reference values.

10. The device according to claim 7, wherein there is a special mode of operation of the production plant in the form of at least one of the following:
change of the production mode, change of the production cell components, particularly of the tool or peripheral devices, change of the operating personnel, change of a control mode, change of the operating procedure, carrying out of maintenance, comments by the user, exceeding of monitoring or warning limits, rejects,
run-in cycles or automatic process optimizations by assistance systems, activity of peripheral devices (e.g. material conveying devices), carrying out regular operations automatically, such as lubrication of components, and
control mode of a flow controller or control mode of a process controller, for instance for controlling an injected volume automatically, presence of alarms at the molding machine or a peripheral device.

11. The device according to claim 7, wherein the visualization of the reference is carried out only in case there is an impairment of a stability of the process state at a certain point of time or for a certain time span, in particular when it is to be attributed to one of the relevant factors.

12. The device according to claim 7, wherein each selected process variable is assigned to at least one logical group by the computing unit, wherein:
at least two different logical groups are provided,
it is preferably provided that logical groups are arranged in at least two hierarchy levels, such that at least one logical group of a lower hierarchy level is assigned to another logical group of a higher hierarchy level, and
for each logical group, a state of the logical group is assessed and/or visualized by the computing unit on the basis of the process variables assigned to this logical group.

13. A production plant which is in data-transmitting connection with a device according to claim 7 by means of a data connection or has such a device.

14. A computer program comprising commands which, when executing the program by a computer, cause the computer to perform the method according to claim 1.

15. The computer-readable data carrier, in particular a storage medium, on which the computer program is saved according to claim 14.

16. A data carrier signal which transmits the computer program according to claim 15.
